(19) United States
(12) Patent Application Publication
(10) Pub. No.: US 2008/0024289 A1
(43) Pub. Date: Jan. 31, 2008

(54) Virtual voice alerts for passing

(76) Inventor: Ernest J. Pino, San Jose, CA (US)

Correspondence Address: Clifton L. Anderson, P.O. Box 1210, Cupertino, CA, 95015, US

(21) Appl. No.: 11/492,338

(22) Filed: Jul. 25, 2006

(51) Int. Cl. B60Q 1/22

(52) U.S. Cl. 340/463

(57) ABSTRACT

A pass-alert system can be mounted on bicycle handlebars to relieve a user (bicyclist) of having to vocalize passing alerts. When the bicyclist approaches a pedestrian from behind, the bicyclist can push a left or right trigger button to cause a phrase such as “passing on the left” to be sounded, alerting the pedestrian of the oncoming bicycle and providing a directional indication to aid in avoiding the bicycle. After a delay, a confirmatory message is sounded such as “thank you” to let the pedestrian know that the source of the alert has passed or is passing. Alternative embodiments accommodate joggers, runners, boaters, skiers, etc.

### BACKGROUND OF THE INVENTION

The present invention provides for safe passing as one person, e.g., a bicyclist, overtakes another, e.g., a jogger. Herein, related art is discussed to aid in understanding the invention: related art labeled “prior art” is admitted prior art; and related art not labeled “prior art” is not admitted prior art.

Bicyclists often sound an alert when they approach from behind other people, who may be walking, jogging, or bicycling more slowly along a common path. The alert makes the person being approached aware of the oncoming bicycle and allows them to take an appropriate action or avoid taking an inappropriate action. For example, the alert may prevent the person being passed from inadvertently moving laterally into the bicyclist's path. Where the path is narrow, the alert may allow the person being passed to move to the side to make way for the bicyclist to pass.

A classic alert involves a bell mounted on the bicycle handlebars. The bicyclist would actuate a lever that generated a pair of bell tones. Alternatively, some bicyclists use a horn, generating the necessary air flow by squeezing a bulb attached to the horn's “mouthpiece”. In lieu of such a device, a bicyclist may issue a vocal warning such as “beep beep”. The person being alerted can turn toward the oncoming bicyclist, then determine and take the required action (or inaction) for avoidance.

A more informative alert such as “passing on your left” or “passing on your right” reduces the time and effort required of the recipient to respond appropriately to the alert. The recipient is not required to turn around to determine the intentions of the oncoming bicyclist. Instead, the recipient can either hold course or move slightly to the side away from the passing. Despite the advantages of the more informative alert, many bicyclists rather not utter an extended phrase repeatedly (as they may pass several people in the course of a ride) while they are exerting themselves.

### SUMMARY OF THE INVENTION

The present invention provides a “passer-by” device that generates virtual voice alerts for passing, i.e., electronically produced human-language phrases designed to alert a person that is about to be passed (e.g., by a bicycle). The alert phrase informs the person of the side (e.g., left or right) on which the passing is intended to occur. The alert phrase can be issued in response to a manual activation by the user.

For example, “left” and “right” buttons can be respectively mounted at or near respective handlebar ends where they are readily reachable by respective hands of the bicyclist. When the left button is actuated, the device, which can be separately mounted near the center of the handlebar, emits an informative phrase such as “passing on your left”. Likewise, actuating the right button can cause “passing on your right” to be emitted. In some cases, only one trigger and one phrase may be required, such as “passing on your left”, where passing on the left predominates.

Preferably, the extended phrases continue with a confirmatory message. For example, after the left button is pushed, the phase emitted can be “passing on your left . . . thank you”. With the “thank you” occurring after a delay designed to ensure that the user has overtaken or is overtaking the person at the time the confirmatory phrase is sounded. The “thank you” is not only polite, but lets the person being passed recognize that the act anticipated by the alert has now occurred.

In addition to bicycling, the invention applies to many activities in which someone can pass another on either side. Examples include running, jogging, walking, skating, skiing, snowboarding, and boating.

Of course, the manner of mounting the device and its physical characteristics are adapted to the application. These and other features and advantages of the invention are apparent from the description below with reference to the following drawings.

### BRIEF DESCRIPTION OF THE DRAWINGS

FIG. 1 is a schematic depiction of an embodiment of the invention in use. Pentagons represent humans. Some objects are shown in both the upper and lower halves of FIG. 1, corresponding to their presence at both times T1 and T2.

FIG. 2 is plan view of components of a pass-alert system shown in FIG. 1.

FIG. 3 is a block diagram of the pass-alert system of FIG. 1.

FIG. 4 is a flow chart of a method of the invention practiced using the pass-alert system of FIG. 1.

### DETAILED DESCRIPTION

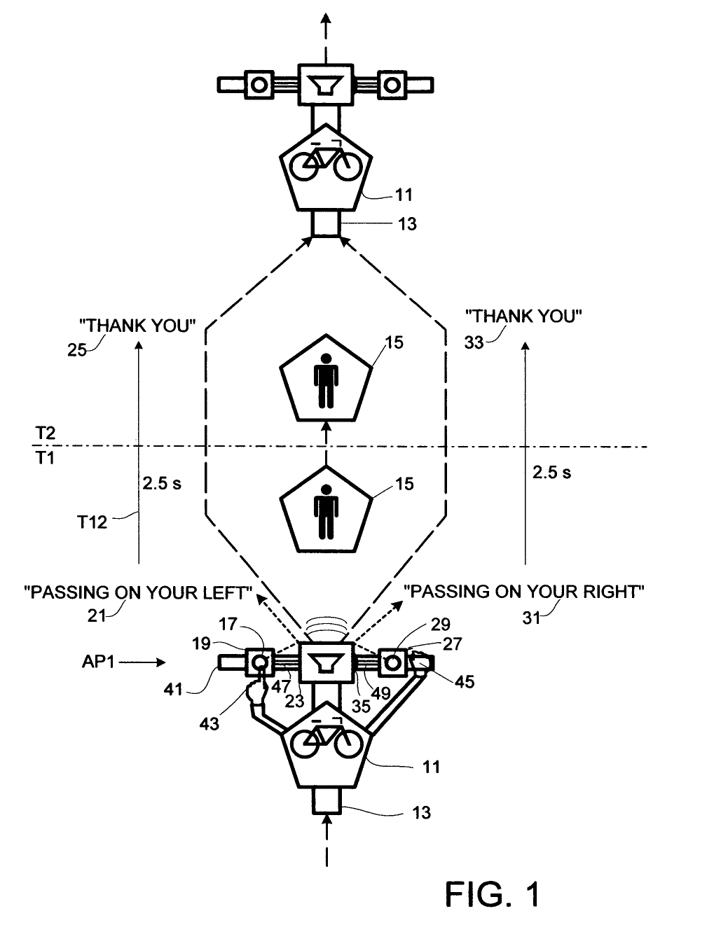

FIG. 1 schematically depicts changes in a scene over a several-second interval T12 from a time T1 to a time T2. At time T1, a bicyclist 11 riding a bicycle 13 approaches a pedestrian 15 from behind. As bicyclist 11 intends to pass pedestrian 15 to the left, bicyclist 11 manually depresses a button 17 on a left trigger module 19. This causes a phrase “passing on your left” 21 to be sounded from a speaker module 23, thereby providing an informative alert to pedestrian 15 with minimal effort on the part of bicyclist 11.

As interval T12 passes, bicyclist 11 passes pedestrian 15. 2.5 seconds after the alert phrase is sounded, a confirmatory phrase “thank you” 25 is emitted from speaker module 23. This confirmatory phrase is sounded in response to the original trigger action, but on a delayed basis. The “thank you” is not just an act of simulated politeness, but serves to identify the bicycle that sounded the alert to the pedestrian, allowing the latter to leave a state of alert.

Speaker module 23 and left trigger module 19 are part of a pass-alert system AP1 that also includes a right trigger module 27 with its own trigger button 29. Trigger button 29; when actuated, causes a “right” pass alert phrase “passing on your right” 31 and then a respective confirmatory “thank you” 33 to be sounded by speaker module 23. The loudness of phrases 21, 25, 31, 33 can be controlled by rotating a volume wheel 35 on speaker module 23.

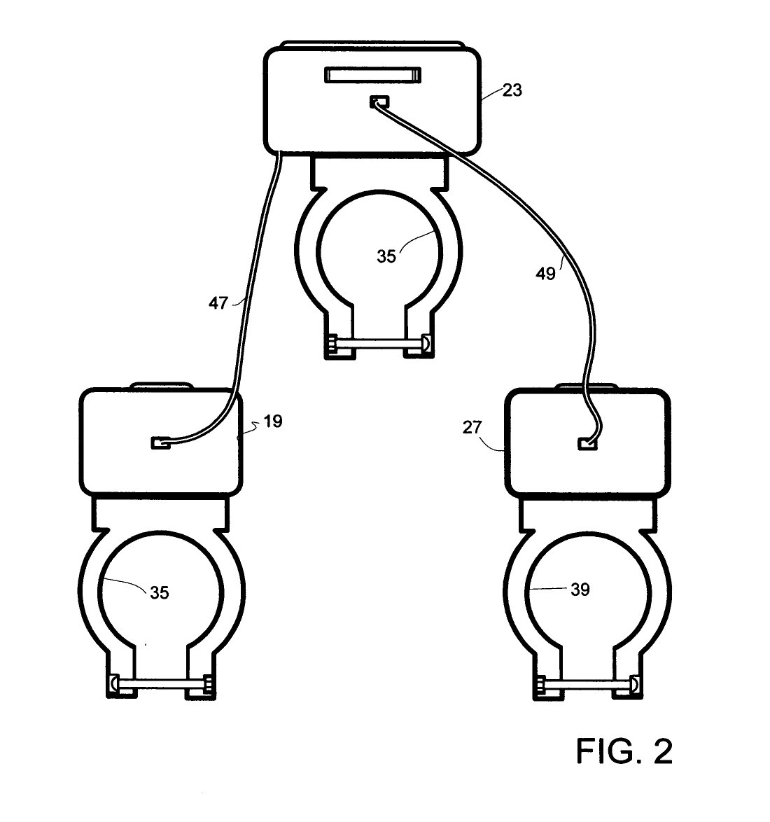

Each of these modules 23, 19, 27 includes a respective clamp 35, 37, 39 (shown in FIG. 2) for attachment to bicycle handlebars 41 (FIG. 1). Left and right trigger modules are disposed near respective left and right ends of handlebars 41 to provide convenient access by respective left and right hands 43 and 45 of bicyclist 11. Speaker module 23 is attached to handlebars 41 at a position between left and right trigger modules 19 and 27. Trigger modules 19 and 27 are communicatively coupled with speaker module 23 via respective cables 47 and 49.

Cables 47 and 49 have connectors at their ends, allowing them to be readily attached and detached from modules 19, 23, and 27 for convenient assembly and disassembly of pass-alert system AP1.

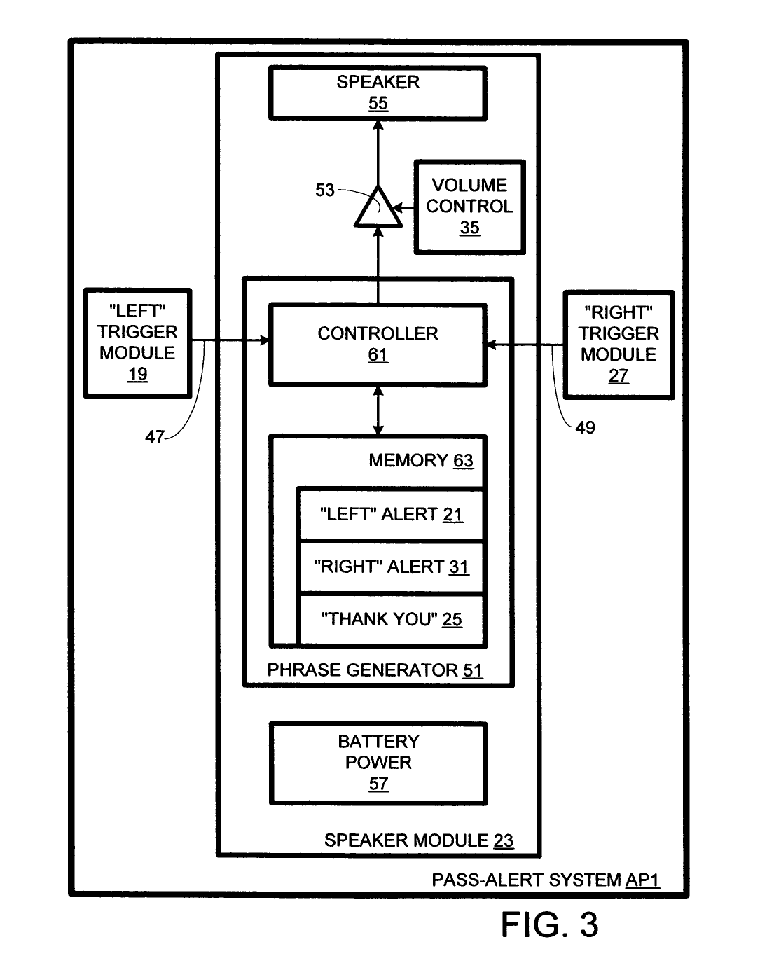

A functional block diagram of pass-alert system AP1 is shown in FIG. 3 including trigger modules 19 and 27 and speaker module 23. Speaker module 23 includes a phrase generator 51, an amplifier 53, volume control 35, a speaker 55, and battery power 57. Volume control 35 controls the gain of amplifier 53, and, thus, the loudness of the phrases emitted by speaker module 23. Phrase generator 51 includes a controller 61 and memory 63. Memory 63 stores digital versions of left pass-alert phrase 21, right pass-alert phrase 31, and confirmatory “thank you” phrase 25 (also serving as “thank you” phrase 31). Power is provided by a pair of AA batteries, but AAA batteries or other batteries can be used.

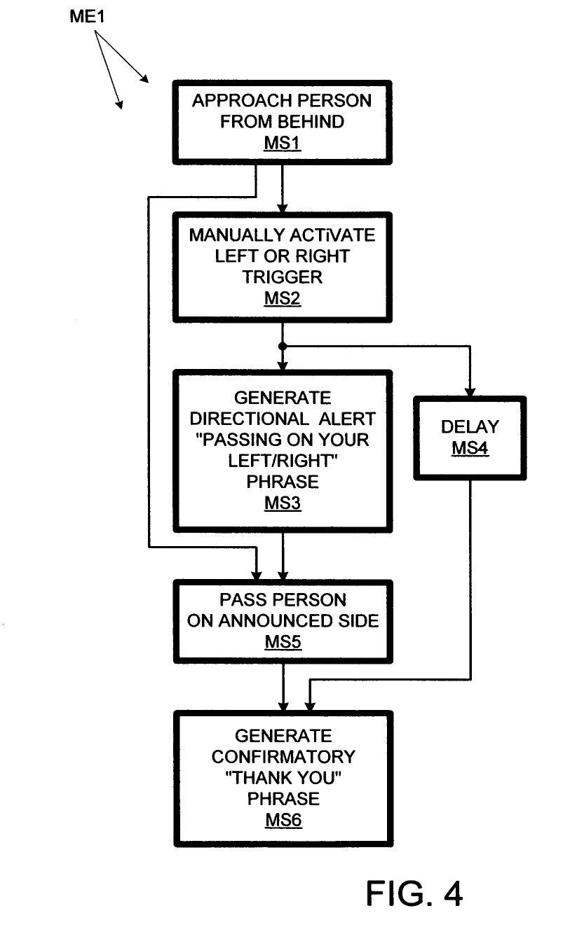

A method of the invention implemented using pass-alert system AP1 is flow charted in FIG. 4. Bicyclist 11 approaches person 15 from behind at method segment MS1. Bicyclist 11 presses either the left or the right trigger button 17, 29 at method segment MS2. In response to the trigger, speaker module 23 generates the respective pass-alert phrase 21, 31 corresponding to the trigger module 19, 27 activated at method segment MS3. In the meantime, controller 61 counts down a 2.5-second delay at method segment MS4. Bicyclist 11 passes person 15 at method segment MS5. When the delay counted down in method segment MS4 lapses, speaker module 23 sounds a confirmatory “thank you” at method segment MS5.

The timing of the confirmatory message is tied to the delay of method segment MS4 rather than to the passing at method segment MS5. This can cause the confirmatory method to be issued earlier or later than optimal. In alternative embodiments, the timing of the confirmatory “thank you” message can be controlled independently of the pass-alert messages. For example, in one embodiment, if the user presses and immediately releases a trigger button, the confirmatory phrase is delayed by a fixed amount, but if the user holds the trigger button down more than one second, the confirmatory phrase is issued upon release of the trigger button. Alternatively, pushing a trigger button twice within a few seconds can cause the second phrase to be confirmatory rather than another alert. In another embodiment, a separate trigger is provided for the confirmatory message.

The invention provides for alternative pass-alert and confirmatory phrases, including phrases in different languages and vocal styles (e.g., male versus female). Pass-alert systems can have fixed phrases or permit selection of phrases. Also, time between fixed alert and confirmatory phrases can be adjustable. In the illustrated embodiment, phrases are generated by playing back prerecorded vocal samples. However, the invention provides as well for synthesized voices.

In the illustrated unit, the trigger modules are separate from the speaker modules. In alternative embodiments, the trigger buttons can be included in a monolithic module including the speaker and phrase generator. Separate buttons can be used for “left” and “right” triggers, or a single lever can be used, moved to the left for “left” and moved to the right for “right”.

The illustrated pass-alert system is powered by batteries. Some embodiments include solar cells for recharging the batteries or a generator that converts vehicle motion into electricity for charging the batteries. In other embodiments, solar or mechanical energy can be converted to electrical energy to power a pass-alert system without storing the electricity in a battery.

The illustrated embodiment comprises three modules that can be attached separately, allowing optimal placement of triggers near handlebar grips and of the speaker in a central location, which gives the person being approached the most accurate location of the bicycle.

However, the present invention allows for all components to be integrated into a single module, which can be attached either at a central position or at a handlebar end (e.g., the end most commonly used for passing, which is normally left). Alternatively, a two-module approach can be used, one module bearing the control circuitry and one trigger, with a second trigger module mounted on the opposing end of the handlebars.

FIG. 1 depicts the present invention in use by a bicyclist about to pass a pedestrian, e.g., a person walking, running, or jogging. Obviously, the invention would apply regardless of how the person to be passed is moving. The person to be passed could be on skates, a tricycle, a unicycle, bicycle, a tandem bicycle, skates, a skateboard, a scooter, etc. The invention can also accommodate a variety of user “types”. For example, the invention can be used by runners, a joggers, skiers, snowboarders, boaters, etc. Some adjustment is required in the location and means for attaching the pass-alert system. For example, a jogger or a skier might need to attach some or all of the system to self. The invention also provides for attaching a pass-alert system to a scooter, a boat, a snow mobile, etc. Of course, a pass-alert system in accordance with the invention can be built into a vehicle prior to first sale. These and other variations upon and modifications to the disclosed embodiments are provided for by the present invention, the scope of which is defined by the following claims.

What is claimed is:

1. A passing alert system comprising:
trigger means for generating a trigger signal in response to manual activation by a user;
phrase-generation means for generating in response to said trigger signal an electrical analog of a human-cognizable audio alert phrase for alerting a person that a user of said alert system is approaching from behind and for indicating a side on which said user can be expected to pass said person; and
speaker means for converting electrical analogs of phrases into respective audio phrases so that said person can hear them.

2. A passing alert system as recited in claim 1 wherein said phrase generation means generates, in response to said trigger signal, an electrical analog of a confirmatory phrase delayed with respect said electrical analog of said audio alert phrase by at least one second.

3. A passing alert system as recited in claim 1 further comprising attachment means for attaching said trigger means, said phrase-generation means, and said speaker means to said user or to a vehicle operated by said user.

4. A passing alert system as recited in claim 1 wherein said trigger means includes left and right triggers, said left trigger generating a left trigger signal in response to manual activation thereof by said user, said right trigger generating a right trigger signal in response to manual activation thereof by said user, said phrase-generating means generating an electrical analog of a left audio phrase indicating said user can be expected to pass on said person's left, said phrase generating means generating an electrical analog of a right audio phrase indicating said user can be expected to pass on said person's right.

5. A passing alert system as recited in claim 4 wherein said phrase generator generates respective electrical analogs of confirmatory audio phrases in response to respective trigger signals and delayed by at least one second relative to respective electrical analogs of audio alert phrases.

6. A passing alert system as recited in claim 4 wherein said vehicle is a bicycle, said left and right triggers being attached near opposing ends of said handlebars and said speaker being attached to said handlebars in a position between said left and right triggers.

7. A passing alert method comprising:
a user manually activating a trigger so as to generate a trigger signal;
a phrase generator generating, in response to said trigger signal, an electrical analog of a human-cognizable audio alert phrase indicating that said user is approaching a person from behind and indicating on what side of said person said user intends to pass; and
converting said electrical analog to audio form so that said person can hear said phrase.

8. A method as recited in claim 7 wherein said phrase generator further generates, in response to said trigger signal, an electrical analog of a confirmatory phrase delayed with respect to said electrical analog of said alert phrase by at least one second, said converting further involving converting said electrical analog of said confirmatory phrase to audio form so that said person can hear said confirmatory phrase.

9. A method as recited in claim 7 further comprising a step of attaching to said user or a vehicle operated by said user trigger means for converting manual actions into trigger signal, phrase-generating means for generating electrical analogs of audio phrases, and speaker means for converting said electrical analogs to audio phrases.

10. A method as recited in claim 9 wherein said user triggers a left trigger resulting in said speaker means outputting an audio left phrase indicating that said user intends to pass said person on said person's left, and wherein said user triggers a right trigger resulting in said speaker means outputting an audio right phrase indicating said user intends to pass said person on said person's right.

11. A method as recited in claim 10 wherein said right phrase and said left phrase are followed by confirmatory phrases output by said speaker means.

12. A method as recited in claim 11 wherein said trigger means includes left and right triggers attached to handlebars of a bicycle and said speaker means is attached to said handlebars between said left and right triggers.
